(19) United States
(12) Patent Application Publication
(10) Pub. No.: US 2012/0274521 A1
(43) Pub. Date: Nov. 1, 2012

(54) COMPLEX ANTENNA AND COMMUNICATION DEVICE

(75) Inventors: Takashi MINEMURA, Tokyo (JP); Kouji Hayashi, Tokyo (JP); Hiroshi Shimasaki, Tokyo (JP)

(73) Assignee: KABUSHIKI KAISHA TOSHIBA, TOKYO (JP)

(21) Appl. No.: 13/528,635

(22) Filed: Jun. 20, 2012

Related U.S. Application Data
(63) Continuation of application No. 12/710,574, filed on Feb. 23, 2010.

(30) Foreign Application Priority Data
Jun. 8, 2009 (JP) P2009-137580

(51) Int. Cl. H01Q 21/29

(52) U.S. Cl. 343/729

(57) ABSTRACT

A complex antenna which receives or transmits a plurality of electromagnetic waves of different frequencies is provided. A first one of the electromagnetic waves is an alternating magnetic flux. The complex antenna includes a first antenna which receives or transmits the alternating magnetic flux. The complex antenna includes a second antenna arranged such that the first antenna and the second antenna overlap as viewed from a direction in which the alternating magnetic flux penetrates the first antenna. The second antenna is adapted for reducing an induction effect of a current which is induced by the alternating magnetic flux and flows in the second antenna.

### CROSS REFERENCE TO RELATED APPLICATIONS

This is a Continuation of U.S. application Ser. No. 12/710,574, filed Feb. 23, 2010, which application is based upon and claims the benefit of priority from prior Japanese Patent Application No. 2009-137580, filed Jun. 8, 2009, the entire contents of both of which are incorporated herein by reference.

### BACKGROUND OF THE INVENTION

1. Field of the Invention

The present invention relates to a complex antenna constituted by an antenna which works by using a change of a magnetic field and an antenna which works by using a change of an electric field combined with each other, and to a communication device which uses the complex antenna.

2. Description of the Related Art

As wireless communication technology comes into wide use in recent years, the chances increase that communication devices communicate with each other by using a wireless interface instead of a wired connection such as an AV (audio visual) cable or a USB (universal serial bus) cable. Communication media used by the wireless interface are various, and wireless interfaces which use a far electromagnetic field and use a near electromagnetic field are each put to practical use.

Among them, a communication system which uses a near electromagnetic field in which attenuation of a radio signal is significant is designed in such a way that communication can be performed between a transmitter side antenna and a receiver side antenna put close to each other. As communication can be performed only in a case where both the antennas are close to each other, a radio signal of another user who uses a similar communication system can be prevented from causing interference. Thus, the communication system which uses a near electromagnetic field does not need an authentication process or a ciphering/deciphering process for dealing with interference with another user, and thus can simply perform communication.

A communication system which uses, e.g., an inductive magnetic field among near electromagnetic fields is applied to various uses such as an electronic boarding ticket function of a transportation system for which a ticket gate machine communicates with a communication device or a card, and an electronic account function for which an electronic resister communicates with a communication device, e.g., as disclosed in Japanese Patent Publication of Unexamined Application (Kokai), No. 2002-64403. Meanwhile, a communication system which uses, among near electromagnetic fields, an inductive electric field or a static electric field (simply called inductive electric field, etc. hereafter) being dominant in short range communication which uses an electric field is applied to various uses such as a function for transferring content between an electronic device having a storage device in which music or moving picture content is stored and an electronic device having a player device, e.g., as disclosed in Japanese Patent Publication of Unexamined Application (Kokai), No. 2008-182714.

Such a communication system for performing communication within a short range is generally called a contactless communication system, which particularly comes into wide use in recent years owing to a simple process for use and simplicity of intuitive operation such as putting communication devices close to each other. Further, the contactless communication system is increasingly applied to portable, small-sized communication devices owing to the feature of putting communication devices close to each other.

Uses of the communication system which uses an inductive magnetic field and uses of the communication system which uses an inductive electric field, etc. are different from each other. Thus, there is a demand that a communication device is equipped with a complex antenna which uses the two communication systems so as to provide a service by means of a combination of the two systems. A service of, e.g., settling accounts electronically through an antenna which uses an inductive magnetic field (inductive-magnetic-field-type antenna, shortened as “IMF-type antenna” hereafter) and transferring content of the settled accounts through an antenna which uses an inductive electric field, etc. (inductive-electric-field-&etc-type antenna, shortened as “IEF-type antenna” hereafter) is conceivable.

Incidentally, a portable communication device needs to be made as small as possible so as to enhance portability. Thus, electronic devices provided to the communication device have to be not only made small but also put close to one another. An IMF-type antenna and an IEF-type antenna described above have to be put close to each other in the communication device. Thus, when the IMF-type antenna is used, the IEF-type antenna may possibly be provided with a magnetic flux.

An IEF-type antenna is generally constituted by a planar metal plate called a coupler element. A magnetic flux provided to the metal plate causes electromotive force and a current flowing in the metal plate in accordance with Faraday's law of induction. The current flows like an eddy on a fringe of the metal plate, and is thereby called an eddy current in general. A magnetic flux occurs following the eddy current that flows in the metal plate, and this magnetic field occurs in a direction such that the magnetic flux provided to the metal plate is canceled.

Thus, if the IMF-type antenna and the IEF-type antenna are put close to each other, the magnetic flux coming from the IEF-type antenna causes electromotive force occurring on the IMF-type antenna to be attenuated. An induction current insufficiently flows on the IMF-type antenna as a result, and there is a problem in that communication cannot be satisfactorily performed.

### SUMMARY OF THE INVENTION

Accordingly, an advantage of the present invention is to provide a complex antenna which can reduce interference occurring upon an IEF-type antenna and an IMF-type antenna being arranged close to each other, and to provide a communication device which uses the complex antenna.

To achieve the above advantage, one aspect of the present invention is that a complex antenna which receives or transmits a plurality of electromagnetic waves of different frequencies is provided. A first one of the electromagnetic waves is an alternating magnetic flux. The complex antenna includes a first antenna which receives or transmits the alternating magnetic flux. The complex antenna includes a second antenna arranged such that the first antenna and the second antenna overlap as viewed from a direction in which the alternating magnetic flux penetrates the first antenna. The second antenna is adapted for reducing an induction effect of a current which is induced by the alternating magnetic flux and flows in the second antenna.

### BRIEF DESCRIPTION OF THE DRAWINGS

FIG. 1 shows a configuration of a complex antenna of a first embodiment of the present invention.

FIG. 2 illustrates an occurrence of a canceling magnetic flux of the complex antenna of the first embodiment of the present invention.

FIGS. 3A-3D illustrate occurrence patterns of eddy currents of variations of the complex antenna of the first embodiment of the present invention.

FIGS. 4A-4E illustrate simulation models of the complex antenna of the first embodiment of the present invention.

FIG. 5 shows reflection characteristics of the simulation models shown in FIGS. 4A-4E.

FIGS. 6A-6D illustrate other simulation models of the complex antenna of the first embodiment of the present invention.

FIGS. 7A and 7B shows reflection characteristics of the simulation models shown in FIGS. 6A-6D.

FIGS. 8A-8F show variations of an electric field receiving antenna of the complex antenna of the first embodiment of the present invention.

FIG. 9 shows a configuration of a complex antenna of a second embodiment of the present invention.

FIG. 10 is a schematic circuit diagram of an electric field receiving antenna of the complex antenna of the second embodiment of the present invention.

FIG. 11 shows a configuration of a complex antenna of the embodiment including a magnetic sheet.

FIG. 12 shows a configuration of the complex antenna of the embodiment for which feed points are put apart from each other.

### DETAILED DESCRIPTION OF THE INVENTION

Embodiments of the present invention will be explained hereafter with reference to the drawings.

### First Embodiment

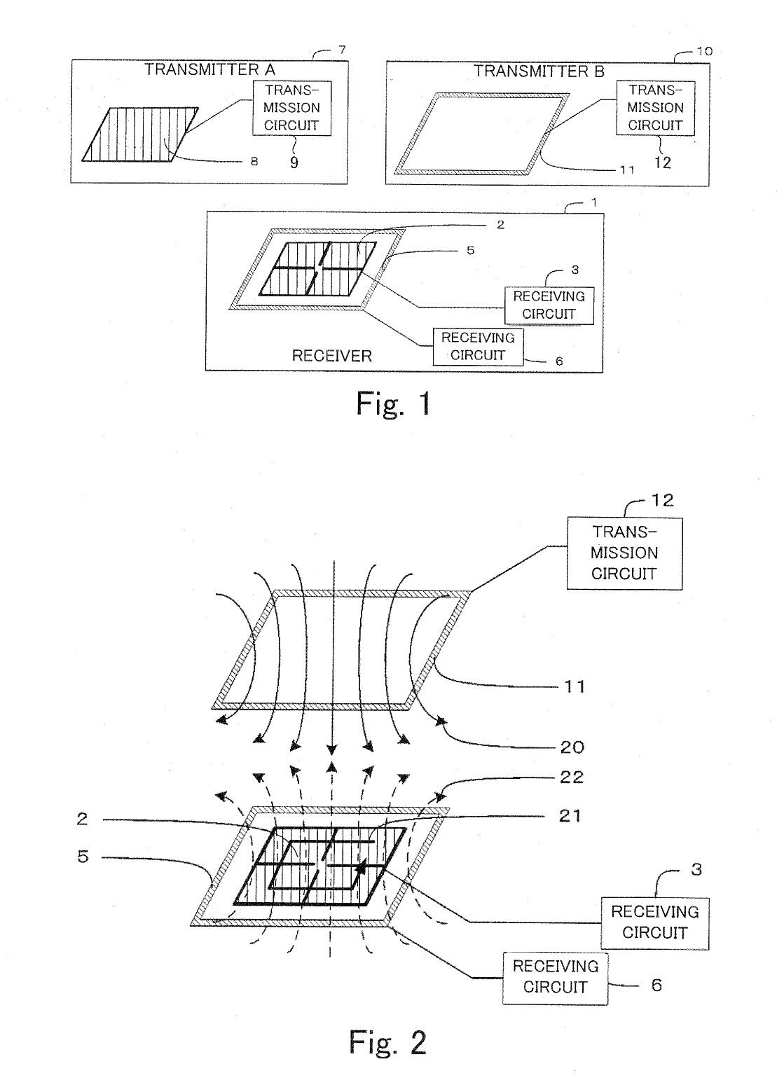

FIG. 1 shows a configuration of a complex antenna of a first embodiment of the present invention.

### (Configuration of Complex Antenna)

FIG. 1 shows a receiver 1 including a complex antenna of the first embodiment and constituted as one by an IEF-type antenna and an IMF-type antenna combined with each other. The IEF-type antenna is constituted by a receiving electrode 2 formed by a planar metal conductor and a receiving circuit 3 which processes a signal carried by a current occurring from the receiving electrode 2. The IMF-type antenna is constituted by a receiving loop 5 formed by a loop of a fine conductive metal wire arranged in such a way as to surround the outside of the receiving electrode 2, and a receiving circuit 6 which processes a signal carried by a current occurring from the receiving loop 5.

FIG. 1 also shows a transmitter 7 as a first transmission section which communicates with the receiver 1. The transmitter 7 is constituted by a transmission electrode 8 to be coupled with the receiving electrode 2 of the receiver 1 so as to emit an inductive electric field, etc. and a transmission circuit 9 which supplies the transmission electrode 8 with power. FIG. 1 also shows a transmitter 10 as a second transmission section constituted by a transmission loop 11 which faces the receiving loop 5 of the receiver 1 and produces a magnetic flux in accordance with an applied electric signal, and a transmission circuit 12 which supplies the transmission loop 11 with power in accordance with an applied electric signal.

In order that the receiver 1 and the transmitter 7 configured as described above communicate with each other, the receiving electrode 2 faces and is coupled with the transmission electrode 8, and the transmission circuit 9 of the transmitter 7 provides the transmission electrode 8 with modulated RF power. To put it specifically, frequencies of 1 GHz-100 GHz are used for the RF. Then, a modulated RF electric field having components parallel and perpendicular to a direction of propagation of the electric field is induced by the transmission electrode 8, and is propagated toward the receiving electrode 2 of the receiver 1. The electric field applied to the receiving electrode 2 causes a modulated RF current which is provided to the receiving circuit 3, and a signal carried by the current is processed by the receiving circuit 3. As most of a so called near electromagnetic field is occupied by electric fields belonging to induced electric fields, quasi-static electric fields and so on, strength of the electric field emitted by the transmission electrode 8 of the transmitter 7 decreases in proportion to a distance from the transmission electrode 8 to the power of 3 or 2. Thus, the receiving electrode 2 of the receiver 1 and the transmission electrode 8 of the transmitter 7 can be electrically coupled and communicate with each other only if being put close enough to each other, e.g., less than 3 cm.

Meanwhile, in order that the receiver 1 and the transmitter 10 communicate with each other, the receiving loop 5 and the transmission loop 11 are put close to each other, and the transmission circuit 12 of the transmitter 10 applies modulated low frequency power to the transmission loop 11. To put it specifically, frequencies of 10-20 MHz are used for the low frequency. Then, a magnetic field occurs from a current flowing through the transmission loop 11, and a portion of the magnetic field is applied to the inside of the receiving loop 5 of the receiver 1. Magnetic flux density inside the receiving loop 5 changes depending on a change of the magnetic field occurring from the transmission loop 11. The change of the magnetic flux density causes an induced current to occur in the receiving loop 5 in accordance with Faraday's law of induction. This induced current is provided to the receiving circuit 6 and a signal carried by the induced current is processed by the receiving circuit 6.

As the magnetic field emitted by the transmission loop 11 of the transmitter 10 is attenuated depending on a distance from the transmission loop 11, the transmission loop 11 and the receiving loop 5 have to be put close to each other for performing communication. The distance between the transmission loop 11 and the receiving loop 5 at which the communication is available varies depending upon a loop size of each and a magnitude of the power provided to the transmission loop 11. The transmission loop 11 and the receiving loop 5 can produce an induced current enough and communicate with each other only if being put close enough to each other, e.g., less than 10 cm for an antenna used for processing an admission ticket of a transportation system. Incidentally, each of the circuits shown in FIG. 1 is grounded at a ground portion that is not shown.

### (Reducing Eddy Current by Forming Slit)

FIG. 2 illustrates occurrence of a magnetic flux in a case where the receiver 1 and the transmitter 10 communicate with each other. As earlier described, the receiving loop 5 of the receiver 1 produces an induced current if a magnetic flux 20 occurring from the transmission loop 11 of the transmitter 10 is applied to the receiving loop 5. As the receiving circuit 6 is provided with the induced current, the transmission circuit 12 of the transmitter 10 and the receiving circuit 6 of the receiver 1 communicate with each other.

Incidentally, the magnetic flux 20 applied to the receiving loop 5 is also applied to the receiving electrode 2 of the IEF-type antenna. If the magnetic flux 20 applied into the receiving electrode 2 changes, an electric field occurs in the receiving electrode 2 in accordance with Faraday's law of induction. The electric field having occurred causes electrons in the receiving electrode 2 to move. If the magnetic flux 20 is applied to the receiving electrode 2 from an upper side as shown in FIG. 2, the electrons in the receiving electrode 2 move around along a fringe of the receiving electrode 2. The move of the electrons going around along the fringe of the receiving electrode 2 can be interpreted as a current. As flowing along the fringe of the receiving electrode 2 like drawing an eddy, this current is generally called an eddy current. The eddy current 21 having occurred in the receiving electrode 2 produces a canceling magnetic flux 22 in accordance with Ampere's law. The canceling magnetic flux 22 occurs in an opposite direction with respect to the magnetic flux 20 applied to the receiving electrode 2 as shown in FIG. 2. As the magnetic flux 20 and the canceling magnetic flux 22 cancel each other out, the amount of the magnetic flux 20 applied to the receiving loop 5 decreases. As the amount of the magnetic flux 20 applied to the receiving loop 5 of the IMF-type antenna decreases, the amount of the induced current occurring in the receiving loop 5 decreases. If the amount of the induced current occurring in the receiving loop 5 decreases, the receiving circuit 6 cannot perform signal processing. Further, existence of the conductor which causes the eddy current 21 in the receiving loop 5 also causes reduction of self inductance due to the eddy current for the transmitting loop 11 put close to and opposite the receiving loop 5 in a case where the receiver 1 and the transmitter 10 communicate with each other. The reduction of the self inductance causes a resonant frequency shift of the transmission loop 11, and consequently degrades communication quality between the receiver 1 and the transmitter 10.

As described above, existence of a conductor in the receiving loop 5 such as the receiving electrode 2 causes various bad effects for the communication between the receiver 1 and the transmitter 10, and preferably no conductor should exist.

Thus, according to the first embodiment, slits are formed in the receiving electrode 2 which is thereby configured to cut the eddy current off. As slits are formed in the receiving electrode 2, components of the eddy current 21 having been cut off which cancel one another out occur, and a total amount of the eddy current 21 occurring in the receiving electrode 2 decreases. The amount of the canceling magnetic flux 22 occurring from the eddy current 21 can thereby be reduced.

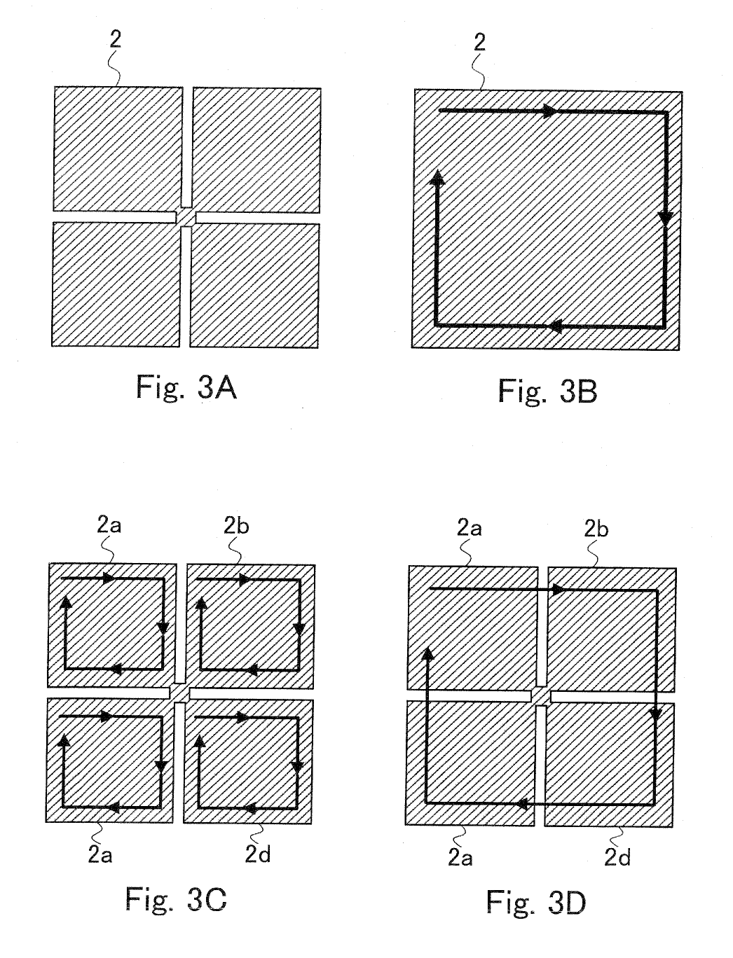

FIGS. 3A, 3C and 3D illustrate shapes of the slits of the receiving electrode 2 and the state of the eddy current 21 occurring inside the receiving electrode 2. As shown in FIG. 3A, e.g., four linear slits are formed from the midpoints of the respective fringe sides for the center of the receiving electrode 2 up, down, rightward and leftward.

FIG. 3C illustrates the occurrence of the eddy current 21 if the magnetic flux 20 is applied into the receiving electrode 2 in which the slits are formed. As shown in FIG. 3C, the slits are formed such that the receiving electrode 2 is divided into four pieces. Thus, from a viewpoint of a current induction process, the receiving electrode 2 in which the slits are formed can be interpreted as a shape combining four small receiving electrodes.

FIG. 3B illustrate the occurrence of the eddy current 21 if the magnetic flux 20 is applied into the receiving electrode 2 in which no slits are formed. An area of each of pieces 2a-2d of the receiving electrode 2 shown in FIG. 3C is a quarter of an area of the receiving electrode 2 shown in FIG. 3B. An amount of the current induced in each of the pieces 2a-2d of the receiving electrode 2 is in proportion to a change of an amount of the magnetic flux 20 applied into each of the pieces 2a-2d. Thus, the amount of the eddy current 21 occurring on each of the pieces 2a-2d is a quarter of that of the eddy current 21 in FIG. 3B.

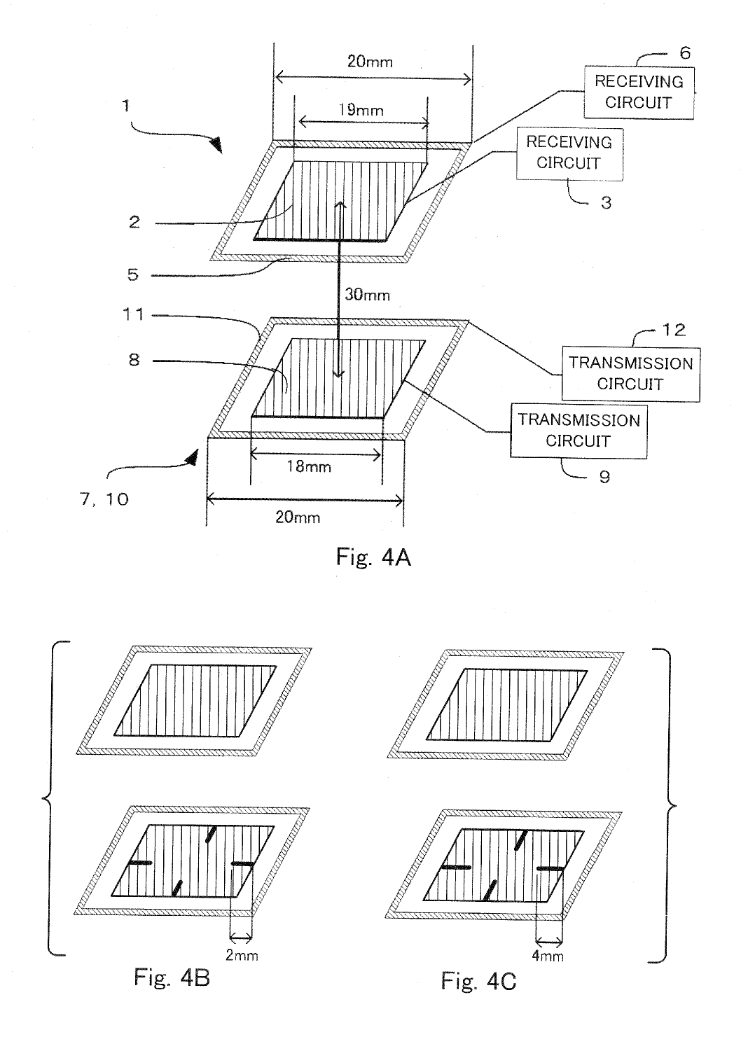

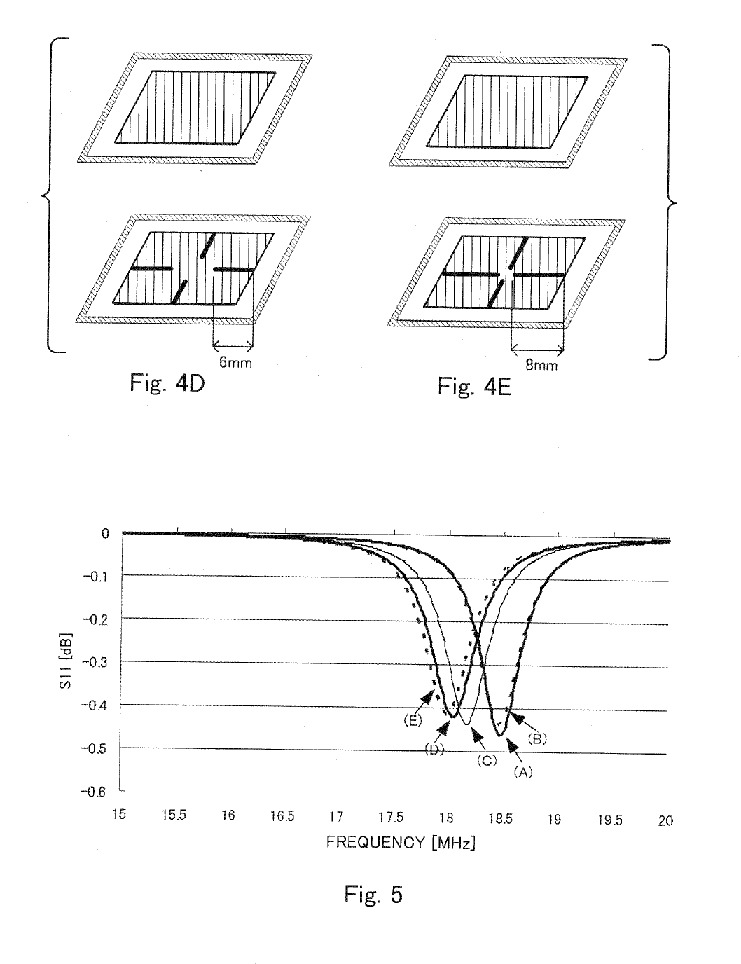

Focus, in FIG. 3C, on a flow of the eddy current 21 occurring in each of the pieces 2a-2d along a portion where adjacent two of the above pieces 2a-2d face each other. As the flows of the eddy current 21 in adjacent two of the pieces 2a-2d along a portion where the two pieces face each other are in opposite directions, the canceling magnetic fluxes 22 due to the respective flows cancel each other out. If the canceled out components of the eddy current 21 are neglected, the eddy current 21 flowing in the receiving electrode 2 in which the slits are formed can be interpreted as the eddy current 21 flowing in the receiving electrode 2 as shown in FIG. 3D. The amount of the eddy current 21 shown in FIG. 4D is reduced as the above components of the eddy current 21 are canceled out as described above, and consequently equals the amount of the eddy current 21 flowing in each of the pieces 4a-4d. It is thereby known that the amount of the eddy current 21 flowing in each of the pieces 2a-2d of the receiving electrode 2 in which the slits are formed is weakened down to nearly a quarter of that in comparison with the receiving electrode in which no slits are formed (FIG. 3B). A difference in boldness between the lines with the arrows shown in FIGS. 3D and 3B indicates the above difference.

As the amount of the eddy current flowing in the receiving electrode 2 is weakened, the amount of the canceling magnetic flux 22 produced by the receiving electrode 2 decreases. Thus, as the amount of the canceling magnetic flux 22 decreases even if the magnetic flux 20 is applied to both of the receiving loop 5 and the receiving electrode 2, the receiving loop 5 can keep the amount of the induced current and maintain communication. Incidentally, the receiving electrode 2 is usually formed in such a way that it is larger than the transmission electrode 8. As the size of the receiving electrode 2 grows, the amount of the magnetic flux 20 applied to the receiving electrode 2 increases and the occurring amounts of the eddy current 21 and the canceling magnetic flux 22 conceivably increase. The slits formed in the receiving electrode 2 where the occurring amount of the canceling magnetic flux 22 is great are conceivably quite effective in suppressing the occurrence of the canceling magnetic flux 22.

The slits are formed in the receiving electrode 2 as described above. The slits of the same shape as those formed in the receiving electrode 2 may be formed in the transmission electrode 8.

If the transmitter 7 and the transmitter 10 are formed as one, the transmission electrode 8 of the transmitter 7 receives a magnetic flux transmitted from the transmission loop 11 of the transmitter 10 and an eddy current occurs in the transmission electrode 8. The eddy current which occurs in the transmission electrode 8 ends up producing a canceling magnetic flux similarly as the eddy current which occurs in the receiving electrode 2 of the receiver 1. Thus, owing to the slits formed in the transmission electrode 8 of the transmitter 7, occurrences of the eddy current and the canceling magnetic flux can be suppressed, and the transmission circuit 12 of the transmitter 10 can communicate with the receiving circuit 6 of the receiver 1. If the transmitter 7 and the transmitter 10 are formed as one, the transmission loop 11 of the transmitter 10, i.e., a source producing the magnetic flux, is put very close to the transmission electrode 8 of the transmitter 7. Thus, magnetic flux density provided to the transmission electrode 8 and the amount of the occurring canceling magnetic flux increase. The slits formed in the transmission electrode 8 where the occurring amount of the canceling magnetic flux is great are conceivably quite effective in suppressing the occurrence of the canceling magnetic flux.

(Resonant Frequency Shift of Receiving Electrode in which Slits are Formed)

The receiving electrode 2 in which the slits are formed is more effective in suppressing an occurrence of the eddy current 21 than the one in which no slits are formed, which is shown by simulation data, then. FIG. 4 shows a simulation model in which the receiver 1, i.e., a combination of the receiving loop 5 and the receiving electrode 2, faces the transmitters 7 and 10, i.e., a combination of the transmission loop 11 and the transmission electrode 8. The size of each of the portions of the receiver 1 and the transmitters 7 and 10 and the vertical distance between the receiver 1 and the transmitters 7 and 10 are shown in FIG. 4A. FIGS. 4A and 4B-4E show a simulation model in which no slits are formed in the transmission electrode 8 and simulation models in which the slits are formed in the transmission electrode 8, respectively. FIGS. 4B-4E show four cases with respect to the lengths of the slits in a range of 2-8 millimeters.

As described earlier, the magnetic flux caused by the transmission loop 11 of the transmitter 10 is provided to the transmission electrode 8 of the transmitter 7. As the transmission electrode 8 causes a canceling magnetic flux, the magnetic flux and the canceling magnetic flux cancel each other out. Thus, the amount of the magnetic flux caused by the transmission loop 11 of the transmitter 10 is smaller than that in a case where the transmission electrode 8 does not exist. The transmission loop 11 can be thought of as an inductor on this occasion. Thus, a product of the amount of the current provided to the transmission loop 11 and self-inductance of the transmission loop 11 is in proportion to the amount of the magnetic flux caused by the transmission loop 11. The amount of the magnetic flux caused by the transmission loop 11 is reduced by the insertion of the transmission electrode 8, and this reduction can be interpreted as a reduction of the inductance of the transmission loop 11. Incidentally, a resonant frequency of the transmission loop 11 of the transmitter 10 and the receiving loop 5 of the receiver 1 is in inverse proportion to a product of their inductance and capacitance values. Thus, the insertion of the transmission electrode 8 of the transmitter 7 causes a reduction in apparent inductance of the transmission loop 11, resulting in that the resonant frequency increases.

FIG. 5 shows spectra of reflected power on the transmission circuit 12 upon a signal of 10-20 MHz frequencies being emitted from the transmission loop 11 of the transmitter 10. As shown in FIG. 5, an increase of the resonant frequency in any one of cases (B)-(E) indicated in FIG. 5 where slits are formed is suppressed in comparison with a case (A) indicated in FIG. 5 where no slits are formed. Taking an increase of the resonant frequency caused by the insertion of the transmission electrode 8 into the transmission loop 11 into account, the reduction of the inductance of the transmission electrode 8 is conceivably suppressed by the formed slits. Hence, the formed slits conceivably suppress the occurrence of the eddy current.

### (Limitation of Slit Shape)

As described above, a slit is effective in suppressing occurrences of an eddy current and a canceling magnetic flux regardless of which of the receiving electrode 2 and the transmission electrode 8 the slit is formed in. The formed slit causes, however, a portion where metal conductors are separate from each other by a slit width. The portion where metal conductors are separate from each other works as a capacitor. Thus, the formed slit causes a change of a capacitance component of the receiving electrode 2 or of the transmission electrode 8. In order that the receiving electrode 2 and the transmission electrode 8 are coupled with each other, in particular, the receiving electrode 2 has to be impedance-matched. If the slit formed in the receiving electrode 2 has a large capacitance component, the receiving electrode 2 causes an impedance change and cannot be impedance-matched. In such a case, the receiving electrode 2 is not resonant with the transmission electrode 8 and the communication is disabled.

For such a reason, if a slit is formed in the receiving electrode 2 of the receiver 1, it is necessary to keep the capacitance to such a degree that the receiving electrode 2 and the transmission electrode 8 are resonant. A value of the change of the capacitance upon the slit being formed in the receiving electrode 2 increases in proportion to the slit width. A change of the state in which the receiving electrode 2 and the transmission electrode 8 are resonant caused by the formed slit will be shown by simulation data.

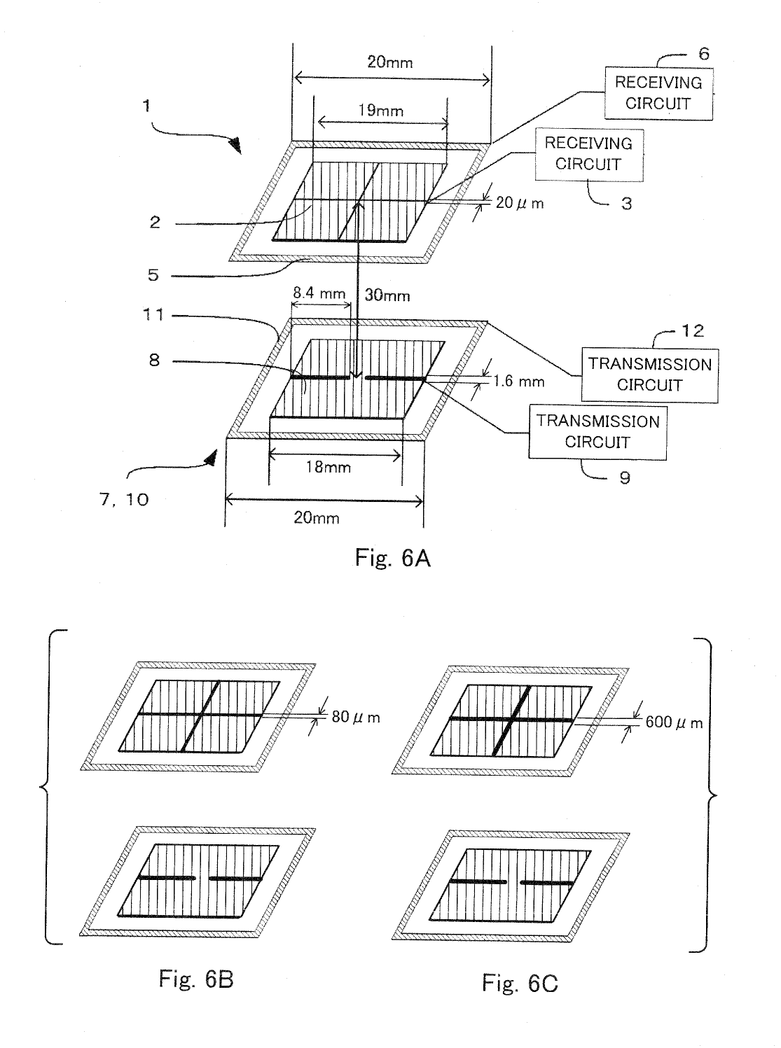

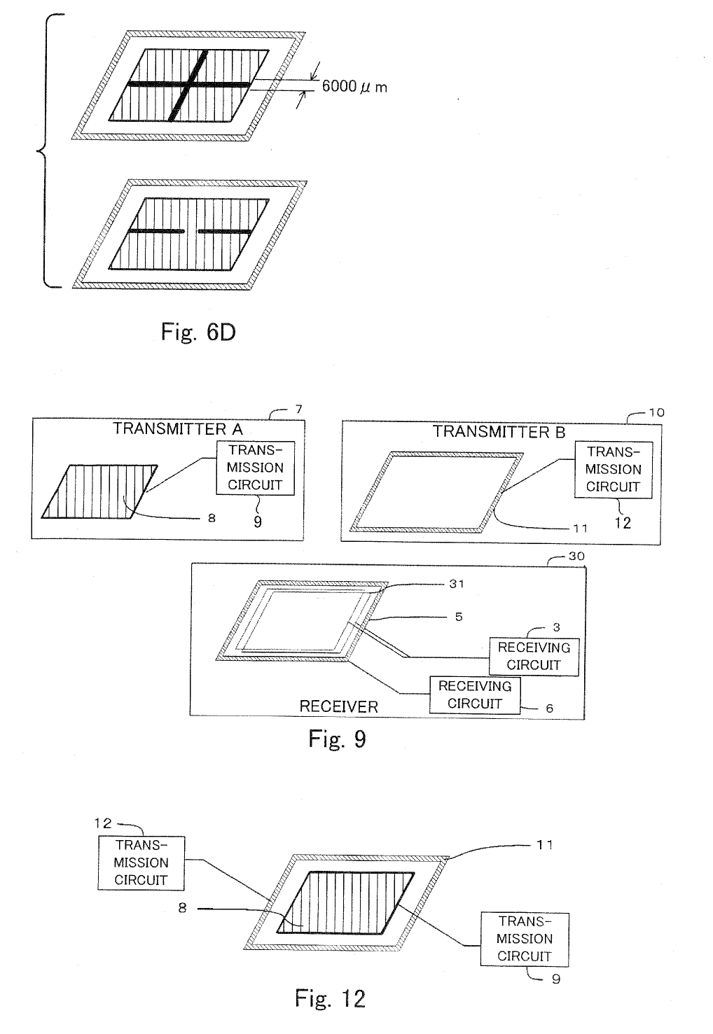

FIGS. 6A-6D shows other models for simulation including the receiver 1 formed by the combination of the receiving loop 5 and the receiving electrode 2, and the transmitters 7 and 10 formed by the combination of the transmission loop 5 and the transmission electrode 8, facing each other. Sizes of respective portions of the receiver 1 and the transmitters 7 and 10, and a vertical distance between the receiver 1 and the transmitters 7 and 10 are as shown in FIG. 6A. As shown in FIGS. 6A-6D, slits of different shapes are formed in the receiving electrode 2 of the receiver 1.

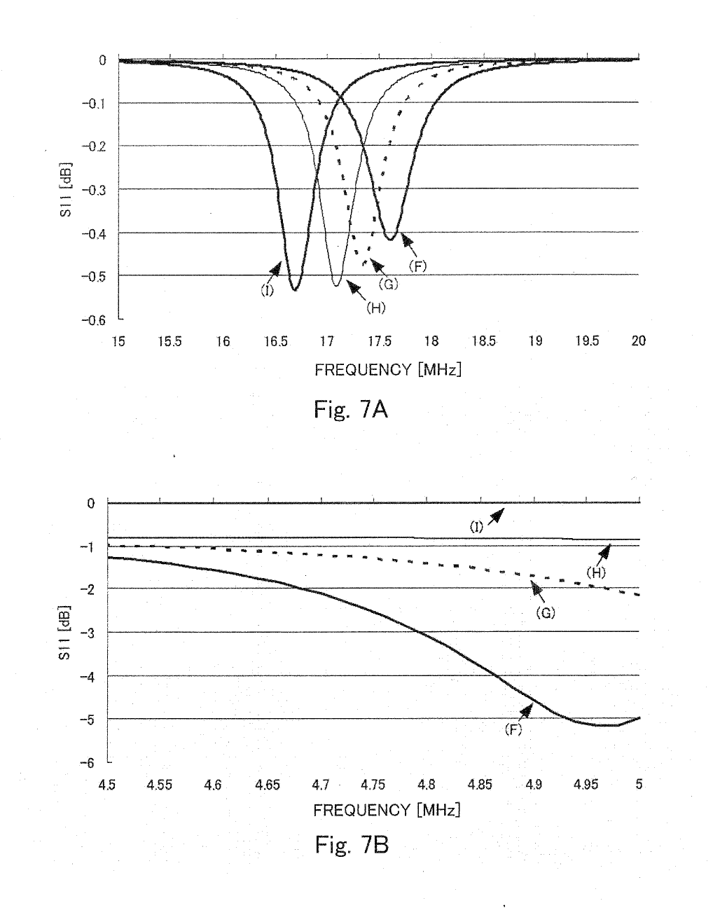

FIG. 7A shows spectra of reflected power on the transmission circuit 12 upon a signal of 15-20 MHz frequencies being emitted from the transmission loop 11 of the transmitter 10. Waveforms of the reflected power spectra (F)-(I) shown in FIG. 7A correspond to the different slits shown in FIGS. 6A-6D, respectively. It is known from the waveforms of the reflected power spectra (F)-(I) shown in FIG. 7A that the resonant frequency is prevented from increasing as the slit width increases with respect to the narrowest width shown in FIG. 6A.

Meanwhile, FIG. 7B shows spectra of reflected power on the transmission circuit 9 upon a signal of 4.5-5 GHz frequencies being emitted from the transmission electrode 8 of the transmitter 7. Waveforms of the reflected power spectra (F)-(I) shown in FIG. 7B correspond to the different slits shown in FIGS. 6A-6D, respectively. It is known from the waveform of the reflected power spectra (F) shown in FIG. 7B that the slit shown in FIG. 6A causes a small increase in the capacitance and a reduced reflection amount in higher frequencies indicating a state of resonance. Reflection amount caused by a wider slit shown in FIG. 6B, however, increases in comparison with the reflection caused by the slit shown in FIG. 6A. It is known that further wider slits shown in FIGS. 6C and 6D cause most of input power to be reflected, and hardly cause resonance.

If a slit is formed in the receiving electrode 2, as described above, the slit prevents the resonant frequency from increasing and an occurrence of a canceling magnetic flux is suppressed. As the slit width increases, however, the capacitance of the receiving electrode 2 changes resulting in that the transmission electrode 8 and the receiving electrode 2 are not resonant and communicate is disabled. To put it specifically, the reflected power needs to be kept below the transmitted power by 2 dB or even less in order that the transmission electrode 8 and the receiving electrode 2 can maintain communication. In order that the reflected power is kept below the transmitted power by 2 dB or even less, the slit needs to be made so narrow that an effect of the capacitance caused by the slit remains in a certain range such that the effect is insignificant in the frequency range where the receiver 1 communicates with the transmitter 7, and is significant enough in the frequency range where the receiver 1 communicates with the transmitter 10. In order that the above condition is satisfied, the slit width needs to be made smaller than one-hundredth wavelength of the frequency to be used for the communication between the receiver 1 and the transmitter 7. The slit width limited as described above, however, is a width of a portion of the slit where the metal plate divided by the slit effectively causes a capacitive coupling. That is, the slit may have a portion whose width is greater than one-hundredth wavelengths as long as the slit width is smaller than one-hundredth wavelength as a whole, or, on average. The slit may have, e.g., an aperture portion having a width greater than one-hundredth wavelength provided on a fringe of the metal plate, or a portion inside the metal plate where the slit width is greater than one-hundredth wavelengths.

### (Various Modifications of Planar Electrode)

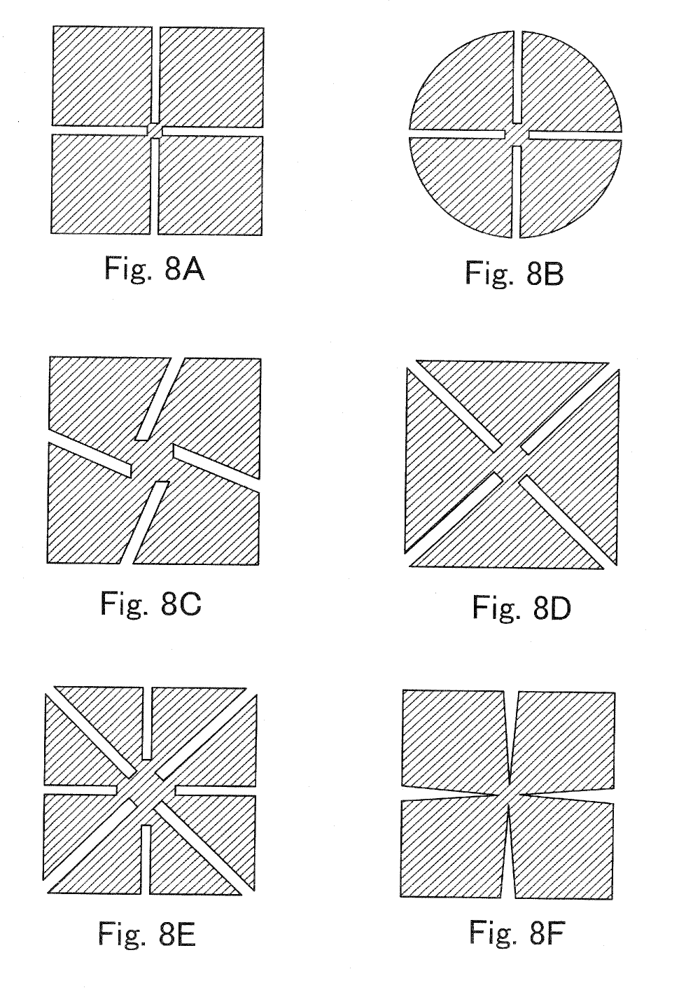

According to the first embodiment, the slits are formed like a cross in the receiving electrode 2 and in the transmission electrode 8 shown in FIG. 8A. Shapes of the metal conductor and the slit for dividing the path on which the eddy current passes and producing the canceling component are not limited to the above. FIGS. 8B-8F show slits variously modified and formed in the receiving electrode 2 and the transmission electrode 8.

As shown in FIG. 8B, e.g., the shape of the metal conductor is not limited to a rectangle, and may be, e.g., a circle, an ellipse, a polygon, or a polygon lacking a portion. As shown in FIG. 8C, e.g., the slit is not limited to one directed towards the center of the metal conductor, and may be formed in a different angle. As shown in FIG. 8D, e.g., the slit is not limited to one formed at the midpoint of a fringe line of the metal conductor, and may be formed, e.g., at a vertex of the metal conductor or at a position on the fringe line apart from the midpoint.

As shown in FIG. 8E, e.g., the number of the slits is not limited to four, and, e.g., eight slits may be may be formed. As shown in FIG. 8F, e.g., the shape of the slit is not limited to a rectangle, and may be a triangle, an ellipse, a polygon, a polygon combined with another polygon, or a shape other than a circle. Further, the metal conductor of the receiving electrode 2 is not limited to one formed by a single plate, and the receiving electrode 2 may be formed as a metal conductor divided into four pieces upon the slits disconnected at the center of the metal conductor, e.g., as shown in FIG. 4E being linked with each other. Further, the metal conductor of the above embodiment is formed, although not limited to, like a plate, and may have a 3D structure such as a metal conductor having a difference in level as well as a slit, or a bent metal conductor.

Further, if the metal conductor is rectangular, a resonant frequency and a bandwidth of the receiving electrode 2 and the transmission electrode 8 are determined by lengths of a longer side and a shorter side of the rectangle, respectively. If the metal conductor is rectangular, its antenna characteristic can be easily calculated.

Further, as the slit is formed in the metal conductor, a path length of a current induced in the metal conductor is extended. The resonant frequency of the receiving electrode 2 and the transmission electrode 8 can thereby be lowered. As the receiving electrode 2 and the transmission electrode 8 are rendered small-sized, the resonant frequency increases in general. As the formed slit lowers the resonant frequency, the receiving electrode 2 and the transmission electrode 8 can be rendered smaller than those having a same resonant frequency and no slits.

Incidentally, it is generally known that an alternating current tends to flow on a surface of a conductor, and that a value of the current decreases as leaving the surface and going deep inside the conductor. A depth at which the current value decreases to 1/e times of the current value on the surface is called a skin depth. The skin depth can be calculated from permeability and conductivity of the conductor and a frequency of the current flowing in the conductor. An amount of a current that flows into a conductor made thinner than the skin depth decreases. Thus, if the receiving electrode 2 and the transmission electrode 8 are made thinner than the skin depth calculated from a modulated wave emitted from the transmission loop 11, the value of the eddy current that flows in the receiving electrode 2 and the transmission electrode 8 can be reduced. Incidentally, explanations of a method for calculating the resonant frequency of the receiving electrode 2 and the transmission electrode 8, and of a method for calculating the skin depth in the conductor are omitted.

### Second Embodiment

FIG. 9 shows a configuration of a receiver 30 constituted by a complex antenna of the second embodiment of the present invention.

The receiver 30 of the complex antenna is constituted by a combination of an IEF-type antenna and an IMF-type antenna similarly as the first embodiment. The IEF-type antenna is constituted by an electric field receiving loop 31 formed by a plurality of loops of a fine conductive metal wire, and a receiving circuit 3 which processes a signal carried by a current occurring from the electric field receiving loop 31.

Meanwhile, the IMF-type antenna is constituted by a receiving loop 5 formed by a loop of a fine conductive metal wire arranged in such a way as to surround the outside of the electric field receiving loop 31, and a receiving circuit 6 which processes a signal carried by a current occurring from the receiving loop 5. Transmitters 7 and 10 are same as those of the first embodiment, and their explanations are omitted.

In order that the receiver 30 communicates with the transmitter 7, the electric field receiving loop 31 of the receiver 30 faces the transmission electrode 8 of the transmitter 7, and the transmission circuit 9 of the transmitter 7 provides the transmission electrode 8 with a modulated RF electric signal. Then, a modulated RF electric field is induced by the transmission electrode 8. The electric field emitted from the transmission electrode 8 is applied to the electric field receiving loop 31 of the receiver 30. Incidentally, it can be viewed as an application of a magnetic field to the electric field receiving loop 31 in accordance with Maxwell's law concerning an electric field and magnetic flux density. The magnetic field provided to the electric field receiving loop 31 produces an induced current in accordance with Faraday's law of induction. As the current is induced in accordance with an RF signal transmitted by the transmission circuit 9, the receiving circuit 3 can identify the transmitted signal from the induced current. A detailed configuration of the IEF-type antenna and a method for transmitting and receiving signals are same as those of the first embodiment, and their explanations are omitted.

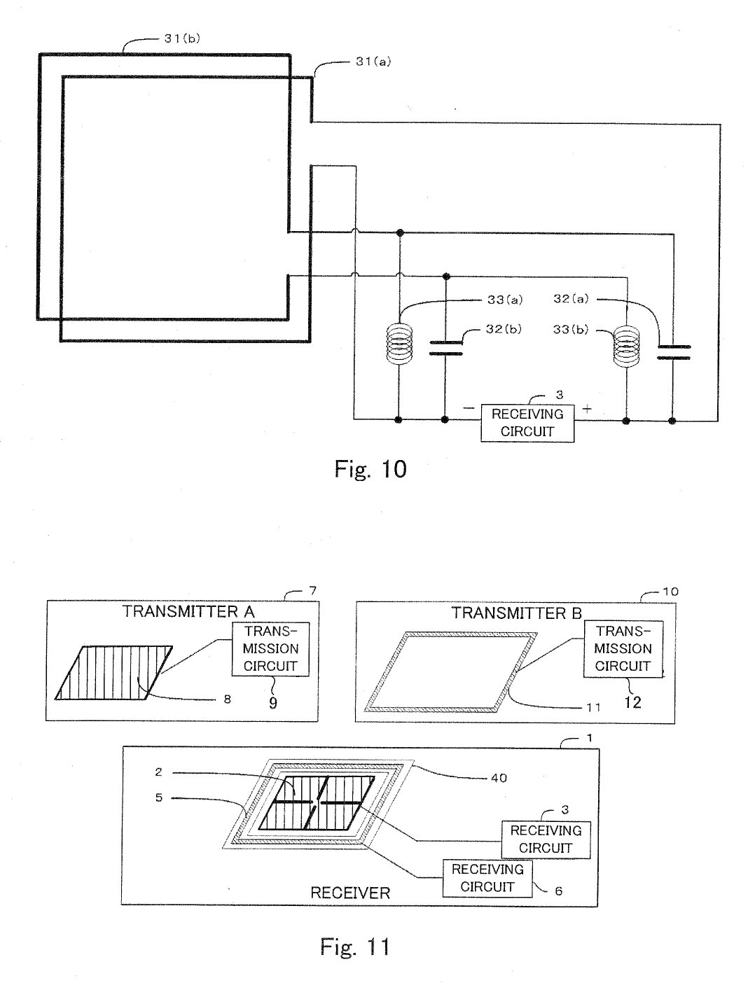

FIG. 10 illustrates a connection between the electric field receiving loop 31 of the receiver 1 and the receiving circuit 3. FIG. 10 shows a case as an example for which the electric field receiving loop 31 is constituted by two loops which are a first electric field receiving loop 31(a) and a second electric field receiving loop 31(b). The number of the loops which constitute the electric field receiving loop 31 is not limited to two, and a plurality of loops may be combined.

The first electric field receiving loop 31(a) and the second electric field receiving loop 31(b) each have respective gaps, and the one and the other ends of the gap are connected to positive and negative side terminals of the receiving circuit 3, respectively. Upper and lower ends of the first electric field receiving loop 31(a) are connected to the positive and negative side terminals of the receiving circuit 3, respectively. Meanwhile, an upper end of the second electric field receiving loop 31(b) is connected to the positive and negative side terminals of the receiving circuit 3 through a capacitor 32(a) and through an inductor 33(a), respectively. Meanwhile, a lower end of the second electric field receiving loop 31(b) is connected to the positive and negative side terminals of the receiving circuit 3 through an inductor 33(b) and through a capacitor 32(b), respectively.

If a signal carried by a modulated RF magnetic field is applied to the electric field receiving loop 31 shown in FIG. 10, currents are induced severally in the first electric field receiving loop 31(a) and in the second electric field receiving loop 31(b). As a magnetic flux is applied to the two loops in a same direction, the induced currents occur in a same direction such as counterclockwise in the loop shown in FIG. 10. The current induced in the first electric field receiving loop 31(a) flows severally into the positive and negative terminals of the receiving circuit 3. Meanwhile, the current induced in the second electric field receiving loop 31(b) passes the inductors 33(a), (b) and the capacitors 32(a), (b).

In general, the inductors 33(a), (b) and the capacitors 32(a), (b) work as a low-pass filter that blocks high frequencies and as a high-pass filter that blocks low frequencies, respectively, in an alternating current circuit. Thus, the current induced in the second electric field receiving loop 31(b) flows into the positive and negative terminals of the receiving circuit 3 through the capacitors 32(a) and 32(b), respectively. As a result, the induced current that flows in the first electric field receiving loop 31(a) and the induced current that flows in the second electric field receiving loop 31(b) flow to the receiving circuit 3 in the same polarity. Thus, the current flows in the circuit and the receiving circuit 3 can perform signal processing by using the current that flows.

Meanwhile, if a signal carried by a modulated low frequency magnetic field is applied to the electric field receiving loop 31, currents are induced severally on the two loops. The current induced in the first electric field receiving loop 31(a) flows into the positive and negative terminals of the receiving circuit 3. The current induced in the second electric field receiving loop 31(b) flows severally into the inductors 33(a), (b) and into the capacitors 32(a), (b). The induced current of the modulated low frequency passes not the capacitors 32(a), (b) but the inductors 33(a), (b). Thus, the current induced in the second electric field receiving loop 31(b) flows into the positive and negative terminals of the receiving circuit 3 through the inductors 33(b) and 33(a), respectively. As a result, the induced current that flows in the first electric field receiving loop 31(a) and the induced current that flows in the second electric field receiving loop 31(b) flow into the receiving circuit 3 in the reverse polarity.

Thus, as the two induced currents cancel each other out, no currents occur in the circuit. Hence, as no induced currents occur even if the electric field receiving loop 31 is provided with a signal carried by a modulated low frequency magnetic field, the canceling magnetic flux 22 does not occur. Thus, even if the receiver 30 communicates with the transmitter 10, the receiving circuit 3 can properly receive a signal.

Incidentally, the second embodiment has taken up an example for which the IEF-type antenna of the receiver 30 is formed by a fine conductive metal wire. The transmission electrode 8 in the transmitter 7, however, may be formed by a fine conductive metal wire that is similarly formed as the electric field receiving loop 31. In such a case where the receiver 30 is formed by the transmitter 7 and the transmitter 10 as one, the transmission electrode 8 may conceivably produce a canceling magnetic flux upon receiving a magnetic flux provided from the transmission loop 11. The transmission electrode 8 is formed by a fine conductive metal wire formed as described earlier so that a canceling magnetic flux can be prevented from occurring and that the receiver 30 can communicate with the transmitter 10.

### (Magnetic Shield)

FIG. 11 shows a configuration of a receiver 1 having a magnetic sheet 40 inserted below the receiving loop 5. The magnetic sheet 40 is formed by substance of high permeability such as ferrite.

If the transmitter 10 communicates with the receiver 1, the magnetic flux 20 provided from the transmission loop 11 of the transmitter 10 is applied to the receiving loop 5 of the receiver 1. As the magnetic sheet 40 has high permeability, the magnetic flux 20 remains in the magnetic sheet 40 after passing the receiving loop 5. Although a grounded pattern that is not shown is provided below the magnetic sheet 40, an amount of the magnetic flux 20 applied to the grounded pattern can be reduced as the magnetic flux 20 remains in the magnetic sheet 40. As the amount of the magnetic flux 20 applied to the grounded pattern decreases, an amount of an eddy current occurring in the grounded pattern is suppressed. As the amount of the eddy current is suppressed, the amount of the canceling magnetic flux is suppressed and performance of the receiving loop 5 for communication can consequently be maintained.

A magnetic material such as the magnetic sheet 40 is ordinarily arranged even inside a loop such as the receiving loop 5 for being used as a magnetic shield, so that the magnetic sheet has an effect of collecting the magnetic flux applied from the outside. The magnetic sheet 40 of the complex antenna of the present invention is, however, is shaped like a fence and is arranged below the receiving loop 5. Thus, the magnetic sheet 40 and the receiving electrode 2 can structurally avoid being close to each other. Although the magnetic sheet 40 has, as a magnetic material, a characteristic of high loss in the RF range, the transmission electrode 8 can communicate with the receiving electrode 2 in the RF range without being affected by the loss of the magnetic sheet 40 as the magnetic sheet 40 and the receiving electrode 2 are apart from each other,

Incidentally, FIG. 11 shows an example for which the receiving electrode 2 is formed by a plane metal conductor in which a slit is formed. The receiving electrode 2 may be formed, however, by the electric field receiving loop 31 instead of the receiving electrode 2 so that a similar effect of the invention can be obtained. Further, the magnetic sheet 40 is formed, although not limited to, below the receiving loop 5, and may be formed above the transmission loop 11. If the transmitter 7 and the transmitter 10 are formed as one, the transmission electrode 8 may conceivably produce a canceling magnetic flux upon receiving a magnetic flux provided from the transmission loop 11. The magnetic sheet 40 arranged above the transmission loop 11 absorbs the magnetic flux provided from the transmission loop 11 to the transmission electrode 8. Hence, the amount of the eddy current occurring in the transmission electrode 8 and the occurrence of the canceling magnetic flux are suppressed and the receiver 1 can communicate with the transmitter 10.

Although the above embodiments take up cases where the receiver 1 communicates with the transmitter 10, the IEF-type antenna and the IMF type antenna may conceivably interfere with each other in a case where the receiver 1 communicates with the transmitter 7. If an IEF-type antenna emits an electromagnetic wave and the receiving loop 5, or the transmission loop 11, is an integer times as long as a half wavelength of the electromagnetic wave, the receiving loop 5, or the transmission loop 11, ends up being resonant with the electromagnetic wave. The loop length of the receiving loop 5, or the transmission loop 11, is made smaller than the half wavelength of the electromagnetic wave emitted by the transmission electrode 8, so that the receiving loop 5, or the transmission loop 11, can be prevented from being resonant.

If a transmission circuit is connected to an antenna at an interface and provides the antenna with a signal, a current intensifies at the interface. If two antennas are combined as in the transmitter shown in FIG. 4 or FIG. 6, a feed point of the transmission electrode 8 and a feed point of the transmission loop 11 are close to each other resulting in that the current intensifies and an unintentional current may conceivably flow into the transmission electrode 8 or the transmission loop 11. FIG. 12 shows a configuration of the transmitter 7 or 10 in which positions of the feed points are apart from each other. The positions of the feed points are apart from each other so that the current intensification can be avoided and the unintentional current can be prevented from flowing into the transmission electrode 8 or the transmission loop 11.

If a communication device uses a complex antenna in which an IEF-type antenna and an IMF-type antenna are arranged close to each other and the IMF-type antenna is used, an occurrence of an eddy current in the IEF-type antenna is suppressed owing to the above configuration. Hence, a canceling magnetic flux occurring from the eddy current is suppressed and the IMF-type antenna can be used.

Incidentally, the embodiments show an example for which the receiving loop 5 and the transmission loop 11 are arranged as surrounding the outside of the receiving electrode 2 and the transmission electrode 8, respectively. The receiving electrode 2 and the receiving loop 5 may be arranged, however, as partially overlapping each other, or the receiving electrode 2 may be arranged outside the receiving loop 5, so that a similar effect of the invention can be obtained. If the receiving loop 5 and the transmission loop 11 are arranged as surrounding the outside of the receiving electrode 2 and the transmission electrode 8, respectively, so that effects of reducing an area occupied by the two antennas and making the size of the communication device including the complex antenna small can be obtained.

The present invention is not limited to the above embodiments, and can be implemented by including a modification of each of the portions within the scope of the present invention. The invention may be variously formed by properly combining a plurality of the portions disclosed as to the above embodiments. Some of the portions may be removed from each of the above embodiments.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is:

1. A complex antenna comprising:
a first antenna comprising a substantially planar conductor with a slit, the conductor being coupled to a third antenna of a communication partner by one of an electrostatic field and an induction field, the slit being formed at a point dividing an edge of the substantially planar conductor, and the slit having two sides substantially parallel to each other; and
a second antenna comprising a substantially loop shaped conductor coupled to a fourth antenna of the communication partner by an induction field.

2. The complex antenna according to claim 1, wherein:
the first antenna is for communication by a first modulated wave; and
the second antenna is for communication by a second modulated wave.

3. The complex antenna according to claim 2, wherein a width of the slit is less than one-hundredth wavelengths of the first modulated wave.

4. The complex antenna according to claim 2, wherein the substantially planar conductor is divided into plural parts with a same area by the slit.

5. The complex antenna according to claim 2, wherein a thickness of the first antenna is thinner than a skin depth with respect to a frequency of the second modulated wave.

6. The complex antenna according to claim 2, wherein the second antenna comprises a magnetic material at a surface opposite to a receiving direction of the second modulated wave.

7. The complex antenna according to claim 2, wherein a length of the loop conductor of the second antenna is less than half a wavelength of the first modulated wave.

8. The complex antenna according to claim 2, wherein the second antenna is provided to surround the first antenna.

9. A communication device comprising:
a first antenna comprising a substantially planar conductor with a slit, the conductor being coupled to a third antenna of a communication partner by one of an electrostatic field and an induction field, the slit being formed at a point dividing an edge of the substantially planar conductor, and the slit having two sides substantially parallel to each other;
a first receiving circuit configured to receive a first modulated wave from the first antenna and to output a first reception signal;
a second antenna comprising a substantially loop shaped conductor coupled to a fourth antenna of the communication partner by an induction field; and
a second receiving circuit configured to receive a second modulated wave from the second antenna and to output a second reception signal.

10. The communication device according to claim 9, wherein:
the first antenna is configured to communicate with a first transmitter configured to irradiate a high frequency modulated electrical signal; and
the second antenna is configured to communicate with a second transmitter configured to irradiate a low frequency modulated electrical signal.
